(19) United States
(12) Patent Application Publication
(10) Pub. No.: US 2013/0238521 A1
(43) Pub. Date: Sep. 12, 2013

(54) INTERPRETING REQUESTS AND PROVIDING RESPONSES IN THE CONTEXT OF A PROCESS

(71) Applicants: Sven Graupner, Mountain View, CA (US); Hamid Reza Motahari Nezhad, Los Altos, CA (US); Claudio Bartolini, Palo Alto, CA (US)

(72) Inventors: Sven Graupner, Mountain View, CA (US); Hamid Reza Motahari Nezhad, Los Altos, CA (US); Claudio Bartolini, Palo Alto, CA (US)

(21) Appl. No.: 13/415,803

(22) Filed: Mar. 8, 2012

(51) Int. Cl. G06Q 10/00

(52) U.S. Cl. 705/345

(57) ABSTRACT

A system including one or more processors and memory. The memory stores computer-executable instructions that control the one or more processors to receive requests, interpret the requests in the context of a process, and provide responses based on interpretations of the requests in the context of the process.

### BACKGROUND OF THE INVENTION

Service sales processes include the collaboration and coordination of teams of sales professionals. Sales governance includes coordinated procedures that allow individuals to function in the larger context of service sales activities. Often, sales governance includes regulating activities among people who have their own views and who do not fully follow documented guidelines.

### BRIEF DESCRIPTION OF THE DRAWINGS

FIG. 1 is a diagram illustrating one example of a computer system that includes a sales governance system and sales management systems.

FIG. 2 is a diagram illustrating one example of a sales system that governs one or more sales processes.

FIG. 3 is a flow chart diagram illustrating one example of a sales system and a sales governance system.

FIG. 4 is a flow chart diagram illustrating one example of a sales system and a sales governance system updating the progress in a sales process.

FIG. 5 is a flow chart diagram illustrating one example of a sales system and a sales governance system receiving material and performing transactions on underlying sales management systems.

FIG. 6 is a flow chart diagram illustrating one example of processing material received from personnel via a fulfillment interpreter.

FIG. 7 is a flow chart diagram illustrating one example of a sales system and a sales governance system creating a sales case.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims. It is to be understood that features of the various embodiments described herein may be combined with each other, unless specifically noted otherwise.

Often, sales governance includes sales management systems, such as a customer relationship management system, a budgeting system, and an approval system. Each of these sales management systems is different and each system evolves independently over time, which results in separate training for each system, additional training for revisions, and different levels of user interaction. Also, the sales management systems are usually only accessible from within a corporation, which prevents sales personnel from accessing the sales management systems via mobile computing devices. In addition, each sales management system is a separate system and information does not flow seamlessly across systems, such that finding information can be difficult and entering and re-entering information into each of the different systems opens up the possibility for error and inconsistency.

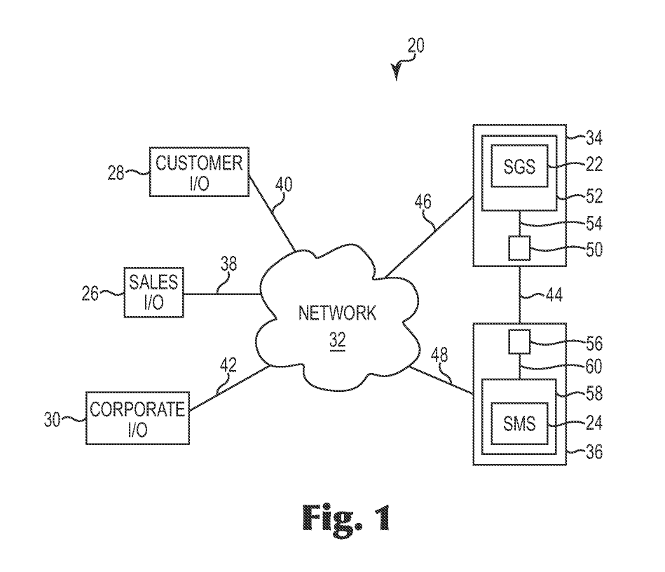

FIG. 1 is a diagram illustrating one example of a computer system 20 that includes a sales governance system (SGS) 22 and sales management systems (SMS) 24. Sales governance system 22 includes an email access layer that mitigates interactions between personnel, such as sales or other personnel, and the different sales management systems 24, such as customer relationship management systems, budgeting systems, and approval systems.

Personnel exchange emails with sales governance system 22, where personnel send requests that can include actions to be performed in a predefined sales process. Sales governance system 22 receives the requests and interprets the requests, including the actions to be performed, in the context of the predefined sales process. Sales governance system responds to the requests based on interpretations of the requests, including the actions to be performed, in the context of the sales process. Sales governance system 22 provides information from and enters information into the underlying sales management systems 24, which mitigates interactions between personnel and the different sales management systems 24. Sales governance system 22 is supported by an action flow execution engine and interfaces with personnel through the exchange of emails. In other examples, sales governance system 22 interfaces with personnel through the exchange of information via one or more other computer messaging systems, such as text messaging, instant messaging, and social networking systems, alone or in combination with email.

Computer system 20 includes sales input/output (I/O) devices 26, customer I/O devices 28, corporate I/O devices 30, a network 32, and servers 34 and 36. In other examples, computer system 20 includes one server or more than two servers, which provide the functionality of servers 34 and 36.

Sales I/O devices 26 are used by sales personnel to communicate over network 32. The sales personnel can communicate with customers at customer I/O devices 28, corporate personnel at corporate I/O devices 30, and servers 34 and 36 over network 32. Sales I/O devices 26 are communicatively coupled to network 32 and customer I/O devices 28, corporate I/O devices 30, and servers 34 and 36 via communications path 38. Each of the sales I/O devices 26 communicates wirelessly and/or via wired connections with network 32. Sales I/O devices 26 include communication devices and can include personal computers, laptop computers, notebook computing devices, tablets, and mobile computing devices, such as telephones and personal digital assistants.

Customer I/O devices 28 are used by customers to communicate over network 32. The customers communicate primarily with sales personnel at sales I/O devices 26. Optionally, customers can communicate with corporate personnel at corporate I/O devices 30 and/or servers 34 and 36 over network 32. Customer I/O devices 28 are communicatively coupled to network 32 and to sales I/O devices 26 and, optionally, to corporate I/O devices 30 and/or servers 34 and 36 via communications path 40. Each of the customer I/O devices 28 communicates wirelessly and/or via wired connections with network 32. Customer I/O devices 28 include communication devices and can include personal computers, laptop computers, notebook computing devices, tablets, and mobile computing devices, such as telephones and personal digital assistants.

Corporate I/O devices 30 are used by corporate personnel to communicate over network 32. Corporate personnel include sales management and corporate executives. Corporate personnel communicate with sales personnel at sales I/O devices 26 and with servers 34 and 36 and, optionally, with customers at customer I/O devices 28 over network 32. Corporate I/O devices 30 are communicatively coupled to network 32 and to sales I/O devices 26, customer I/O devices 28, and servers 34 and 36 via communications path 42. Each of the corporate I/O devices 30 communicates wirelessly and/or via wired connections with network 32. Corporate I/O devices 30 include communication devices and can include personal computers, laptop computers, notebook computing devices, tablets, and mobile computing devices, such as telephones and personal digital assistants.

Network 32 is a collection of hardware and software components interconnected by communication channels that allow sharing of resources and information. Network communications in network 32 can be wireless and/or via wired connections. In various examples, network 32 includes networks, such as the Internet, an intranet, local area networks (LANS), wide area networks (WANS), mobile networks, and enterprise networks.

Servers 34 and 36 include hardware and software components of sales governance system 22 and sales management systems 24. Servers 34 and 36 communicate with each other via communications path 44. Servers 34 and 36 communicate with sales personnel at sales I/O devices 26, customers at customer I/O devices 28, and corporate personnel at corporate I/O devices 30 over network 32. Server 34 is communicatively coupled to network 32 and to sales I/O devices 26, customer I/O devices 28, and corporate I/O devices 30 via communications path 46. Server 36 is communicatively coupled to network 32 and to sales I/O devices 26, customer I/O devices 28, and corporate I/O devices 30 via communications path 48. Each of the servers 34 and 36 communicates wirelessly and/or via wired connections with network 32.

Server 34 includes one or more processors 50 that execute computer executable instructions stored in memory 52. The one or more processors 50 are communicatively coupled to memory 52 via communications path 54. The computer-executable instructions stored in memory 52 control the one or more processors 50 to provide sales governance system 22. The one or more processors 50 are on one or more integrated circuit chips. In various examples, the one or more processors 50 include a microprocessor, a controller, a central processing unit, and/or other logic units.

Memory 52 is a computer readable storage medium storing computer-executable instructions that control the one or more processors 50. Memory 52 is a non-transitory computer readable storage medium. In various examples, memory 52 is volatile memory, such as random access memory (RAM), and/or non-volatile memory, such as read-only-memory (ROM), programmable ROM (PROM), erasable PROM (EPROM), electrically EPROM (EEPROM), flash memory, a hard disk drive, and/or a removable hard disk drive.

Server 36 includes one or more processors 56 that execute computer executable instructions stored in memory 58. The one or more processors 56 are communicatively coupled to memory 58 via communications path 60. The computer-executable instructions stored in memory 58 control the one or more processors 56 to provide the sales management systems 24. The one or more processors 56 are on one or more integrated circuit chips. In various examples, the one or more processors 56 include a microprocessor, a controller, a central processing unit, and/or other logic.

Memory 58 is a computer readable storage medium storing computer-executable instructions that control the one or more processors 56. Memory 58 is a non-transitory computer readable storage medium. In various examples, memory 58 is volatile memory, such as random access memory (RAM), and/or non-volatile memory, such as read-only-memory (ROM), programmable ROM (PROM), erasable PROM (EPROM), electrically EPROM (EEPROM), flash memory, a hard disk drive, and/or a removable hard disk drive.

Sales governance system 22 communicates with network 32 and sales I/O devices 26, customer I/O devices 28, and corporate I/O devices 30 via communications path 46. Sales governance system 22 communicates with sales management systems 24 via communications path 44. Sales governance system 22 is stored in memory 52 and executed on the one or more processors 50 in server 34. In other examples, sales governance system 22 is stored in memory on multiple servers and executed on one or more processors in the multiple servers.

The sales management systems 24 include a customer relationship management system for tracking sales activities, a budgeting system for planning and monitoring sales pursuit initiatives, and an approval system for reaching sales closure. The sales management systems 24 communicate with network 32 and sales I/O devices 26, customer I/O devices 28, and corporate I/O devices 30 via communications path 48. Also, the sales management systems 24 communicate with sales governance system 22 via communications path 44. The sales management systems 24 are stored in memory 58 and executed on the one or more processors 56 in server 36. In other examples, the sales management systems 24 are stored in memory on multiple servers and executed on one or more processors in the multiple servers.

Sales governance system 22 is a central access point for collateral information, such as forms, spreadsheets, calculators, pricing, slide decks, brochures, other documents, and reference contacts for completing each step in a sales process. Sales governance system 22 is a central access point for locating correct and up-to-date information on the sales process and for exchanging this information with personnel. Sales governance system 22 is accessible to substantially all sales personnel uniformly and consistently.

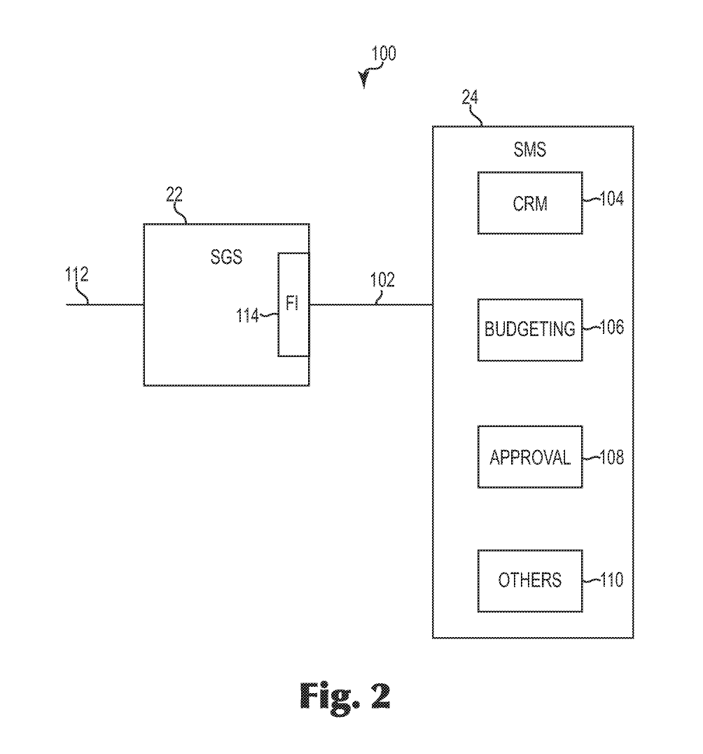

FIG. 2 is a diagram illustrating one example of a sales system 100 that governs one or more sales processes. System 100 includes sales governance system 22 and sales management systems 24, which are stored and executed on computer system 20. Sales governance system 22 and sales management system 24 are communicatively coupled via communications path 102. Sales management systems 24 include a customer relationship management system (CRM) 104 for tracking sales activities, a budgeting system 106 for planning and monitoring sales pursuit initiatives, an approval system 108 for reaching sales closure, and other systems 110 for governing sales.

Sales governance system 22 receives requests, including requests for actions to be performed in a sales process, from personnel in emails via communications path 112. Each sales process programmed into sales governance system 22 is a predefined sales process that includes steps or actions to be performed that cover the lifecycle of the sales process. One example sales process includes an initial customer contact, a pursuit stage, negotiation approval, closure, and post-sale follow-ups. Sales governance system 22 supports different sales processes for sales activities in different geographies and/or industries. Each of the steps or actions in a sales process can be included in a request. Also, at least upon request, sales governance system 22 publishes the list of actions to be performed in a sales process, such that personnel can analyze the list of actions and select one or more of the actions to be performed from the list of actions.

To submit a request, personnel send an email including a unique character string or tag that indicates the request. In one example, to create a sales case, personnel send an email including the tag phrase “#create_pursuit_initiative”. In other examples, sales governance system 22 communicates with personnel via one or more computer messaging systems, such as email, text messaging, instant messaging, and social networking systems, alone or in combination.

In response to requests, sales governance system 22 interprets the requests in the context of the sales process and provides responses to personnel based on the interpretations of the requests in the context of the sales process. The responses from sales governance system 22 are sent in emails via communications path 112, and include information for personnel in the sales process, such as instructions for performing requested actions and/or templates for performing the actions to be performed. Templates can include instructions for performing the actions to be performed and collateral information, such as forms, spreadsheets, calculators, pricing, slide decks, brochures, other documents, and reference contacts. In one example, sales governance system 22 updates a state of the sales process based on information received in the requests, and sales governance system 22 provides follow-on responses based on updating the state of the process.

Sales governance system 22 receives and responds to a number of different requests including: a request to open or create a new case; a request for a list of actions to be performed in a sales process; a request for a template for an action to be performed in a sales process; a request for the status of an action; a request to update the status of an action; a request to start/stop a sales process; and a request for the status of progress in a sales process.

In one example, sales governance system 22 receives a request to provide a list of actions to be performed in a sales process and sales governance system 22 provides the list of actions to be performed in the sales process in one of the responses. In one example, sales governance system 22 receives a request to provide a status report on at least one of progress in the process and/or progress on an action to be performed in the process and sales governance system 22 provides the status report. In one example, sales governance system 22 receives a request to update instructions and/or a template for an action to be performed in the sales process and sales governance system 22 updates at least one of the instructions and/or the template including collateral information for performing the action to be performed in the process.

Sales governance system 22 includes a fulfillment interpreter (FI) 114 that processes material received from personnel. Upon receiving a template, personnel fill out and compile material according to the instructions in the template. Personnel then send the compiled material to sales governance system 22 in an email via communications path 112. Sales governance system 22 receives the email and fulfillment interpreter 114 processes the material. In one example, sales governance system 22 provides a response that includes instructions for performing one or more follow-on actions after receiving the material.

Fulfillment interpreter 114 activates parsing of the material received from personnel and/or parses the material. Fulfillment interpreter 114 extracts information from the material received from personnel and performs transactions, such as recording information from the material, in the underlying sales management systems 24. Fulfillment interpreter 114 and sales management system 24 are communicatively coupled via communications path 102. In one example, fulfillment interpreter 114 transmits a confirmation message back to personnel after the information has been successfully parsed. In one example, fulfillment interpreter 114 transmits a confirmation message back to personnel after the information has been successfully entered into the underlying sales management systems 24.

In operation, a person sends a request, such as an action to be performed, to sales governance system 22 in an email. The person includes a unique character string or tag for the action and, if available, a case identification character string that uniquely identifies the sales case in the email. Sales governance system 22 receives the email and interprets the request in the context of the sales process, where sales governance system 22 responds with one or more emails including instructions and/or templates to personnel, including personnel other than the person who sent the request, according to the state of the sales process.

In one example, sales governance system 22 responds to a request with a template that includes instructions for performing an action to be performed and collateral information, such as forms, spreadsheets, calculators, pricing, slide decks, brochures, and reference contacts for performing the action to be performed. A sales professional receives the template and compiles the material as instructed in the template. The sales professional then returns the compiled material to sales governance system 22 in one or more emails. Sales governance system 22 receives the compiled material and fulfillment interpreter 114 processes the material. Fulfillment interpreter 114 parses the material, extracts information from the material, and performs transactions, such as recording information from the material, in the underlying sales management systems 24. Fulfillment interpreter 114 also stores the compiled material and/or information from the compiled material according to the case identification character string. Fulfillment interpreter 114 transmits a confirmation message back to personnel after the information has been successfully entered into the underlying sales management systems 24.

In one example, sales personnel request that a sales case be created in a first email that includes a request tag such as “#create_sales_opportunity”. Sales governance system 22 receives the first email and, in response, sales governance system 22 provides a case identification tag, such as “#case_{—}348753”, and a form in a second email, where the case identification tag is used in forthcoming emails between personnel and sales governance system 22. Sales personnel receive the second email, fill out the form, and send the filled out form back to sales governance system 22 in a third email. Sales governance system 22 receives the third email, parses the form, extracts information from the form, and performs transactions, such as storing information, in the underlying sale management systems 24 based on information from the form. In one example, sales governance system 22 also provides a fourth email that directs personnel to qualify the case and respond with a fifth email that either qualifies the case via a “#qualify_pursuit” instruction or aborts the case via an “#abort_case” instruction. Sales governance system 22 maintains the sales process at the current step until it receives the fifth email. If sales governance system 22 receives the “#qualify_pursuit” instruction, sales governance system 22 progresses to the next action in the sales process and sales governance system 22 provides one or more email responses for the next action to personnel in the process. If sales governance system 22 receives the not qualified or “#abort_case” instruction, sales governance system 22 aborts the case.

Sales governance system 22 includes several advantages. Sales governance system 22 shields sales personnel from the complexities and changes in the underlying sales management systems 24. Sales governance system 22 simplifies interactions with the sales management systems 24 into communication mechanisms people are familiar with, such as email, and using computer messaging systems, such as email, provides sales personnel who travel frequently and rely on mobile computing devices access to sales governance system 22. Sales governance system 22 simplifies locating information for a step or action to be performed in a sales process by including instructions and/or templates in response emails. Also, since sales governance system 22 is the central access point and element in system 100, sales governance system 22 reduces roll-out time for sales process changes. In addition, in another aspect, mapping sales personnel messages to exchanges with sales governance system 22 creates a unified recording point for ongoing sales activities and builds a warehouse of information that can be exploited for further analysis, and recording information in a string of emails or email thread facilitates exchanging this information across teams via the email threads.

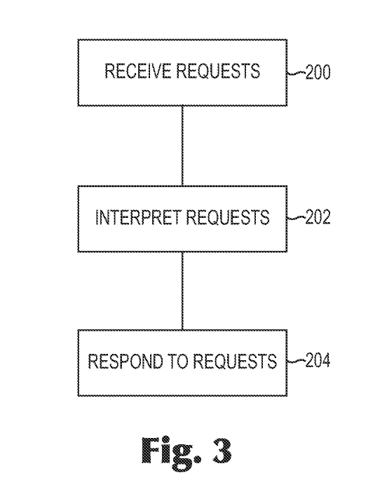

FIG. 3 is a flow chart diagram illustrating one example of sales system 100 and sales governance system 22.

Personnel, such as sales personnel, send requests to sales governance system 22 in emails. Requests include a request to open or create a new case, a request for a list of actions to be performed in a sales process, a request for a template for an action to be performed in a sales process, a request for the status of an action, a request to update the status of an action, a request to start/stop a sales process, and a request for the status of progress in a sales process. Each request includes a unique character string or tag identifying the request and, if created, a unique character string or tag identifying the case. In one example, personnel send an email including the tag phrase “#create_pursuit_initiative” to create a sales case. In other examples, sales governance system 22 communicates with personnel via one or more computer messaging systems, such as email, text messaging, instant messaging, and social networking systems, alone or in combination.

At 200, sales governance system 22 receives the requests, including requests for actions to be performed in a sales process, in the emails. At 202, sales governance system 22 interprets the requests in the context of the sales process, where sales governance system 22 supports different sales processes for sales activities in different geographies and/or industries and each sales process is a predefined sales process that includes steps or actions to be performed over the lifecycle of the sales process.

At 204, sales governance system 22 responds to the requests by providing responses to personnel based on interpretations of the requests in the context of the sales process. These responses are sent from sales governance system 22 to personnel in emails. Each response includes instructions for performing an action and/or a template for performing the action to be performed.

In one example, sales governance system 22 receives a request to create a case and sales governance system 22 provides a case identification character string and a form in response to the request, where the form is to be filled out and returned to sales governance system 22. In one example, sales governance system 22 receives a request to provide a list of actions to be performed in a sales process and sales governance system 22 provides the list of actions to be performed in the sales process in one of the responses. In one example, sales governance system 22 receives a request to provide a status report on at least one of progress in the sales process and/or progress on an action to be performed in the sales process and sales governance system 22 provides the status report. In one example, sales governance system 22 receives a request to update instructions and/or a template for an action to be performed in the sales process and sales governance system 22 updates at least one of the instructions and/or the template including collateral information for performing the action to be performed in the sales process. In one example, sales governance system 22 receives a request to update information on at least one of a sales process, status of the sales process, previous transactions, and previously provided information and sales governance system 22 provides updates as requested.

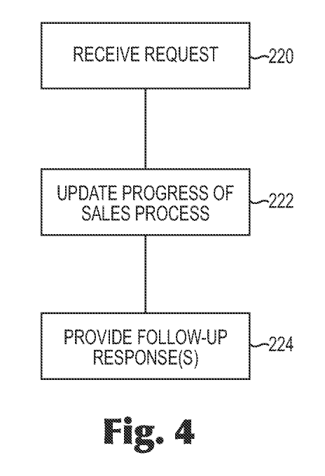

FIG. 4 is a flow chart diagram illustrating one example of sales system 100 and sales governance system 22 updating the progress in a sales process.

Personnel send a request to sales governance system 22, which includes information for updating the progress of the sales process. In one example, personnel send information in reply to a response received from sales governance system 22 and according to instructions received in the response for performing an action in the sales process. In one example, the request includes instructions for sales governance system 22 to qualify the case or abort the case.

At 220, sales governance system 22 receives the request. Sales governance system 22 interprets the request in the context of the sales process and, at 222, sales governance system 22 updates a state of the sales process based on information received in the request. At 224, sales governance system 22 provides follow-on responses based on updating the state of the process. In one example, updating the progress of the sales process triggers sales governance system 22 to provide one or more email responses to various personnel for the next step or action in the sales process, where each response includes instructions and/or a template for performing the action to be performed.

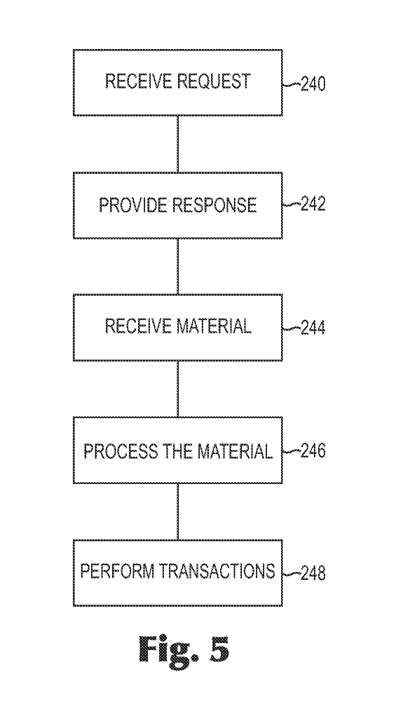

FIG. 5 is a flow chart diagram illustrating one example of sales system 100 and sales governance system 22 receiving material and performing transaction on underlying sales management systems 24 using information from the material.

Personnel, such as sales personnel, send a request to sales governance system 22 in an email. The request indicates an action to be performed in a sales process and includes a unique character string or tag identifying the request and, if created, a unique character string or tag identifying the case.

At 240, sales governance system 22 receives the request, which indicates the action to be performed in the sales process. Sales governance system 22 interprets the request in the context of the sales process. At 242, sales governance system 22 responds to the request by providing a response to the request based on an interpretation of the request in the context of the sales process. A response is sent from sales governance system 22 to one or more people in an email and includes a template for performing the action to be performed as indicated in the request. The template includes instructions for performing the action and collateral information, such as forms, spreadsheets, calculators, pricing, slide decks, brochures, and reference contacts for performing the action to be performed. A person, such as a sales professional, receives the template via email and compiles material as instructed in the template. The person then returns the compiled material to sales governance system 22 in one or more emails.

At 244, sales governance system 22 receives the compiled material and, at 246, sales governance system 22 processes the material to obtain information from the material. At 248, sales governance system 22 performs transactions in the underlying sales management systems 24 using information obtained from the material. In one example, sales governance system 22 provides instructions for performing a follow on action after receiving the material. In one example, sales governance system 22 provides confirmation that the material was successfully processed and/or the transactions were successfully performed in the underlying sales management systems 24. In one example, sales governance system 22 provides instructions for performing a follow on action in the sales process after confirming that the material was successfully processed and/or the transactions were successfully performed in the underlying sales management systems 24.

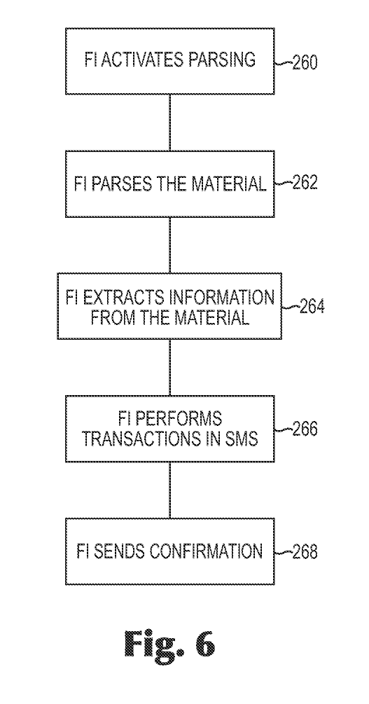

FIG. 6 is a flow chart diagram illustrating one example of processing material received from personnel via fulfillment interpreter 114. Sales governance system 22 receives material, such as compiled material based on template instructions and collateral, in a request or reply from personnel. Fulfillment interpreter 114 processes the material and performs transactions in sales management systems 24.

At 260, fulfillment interpreter 114 activates parsing of the material and, at 262, fulfillment interpreter 114 parses the material. After parsing the material, fulfillment interpreter extracts information from the material at 264. The information extracted from the material is used to perform transaction in the underlying sales management systems 24. At 266, fulfillment interpreter 114 performs transactions, such as recording information from the material, in the underlying sales management systems 24. Optionally, fulfillment interpreter 114 also stores the compiled material and/or information from the compiled material according to the case identification character string. At 268, fulfillment interpreter 114 transmits a confirmation message back to personnel indicating the information has been successfully entered into the underlying sales management systems 24.

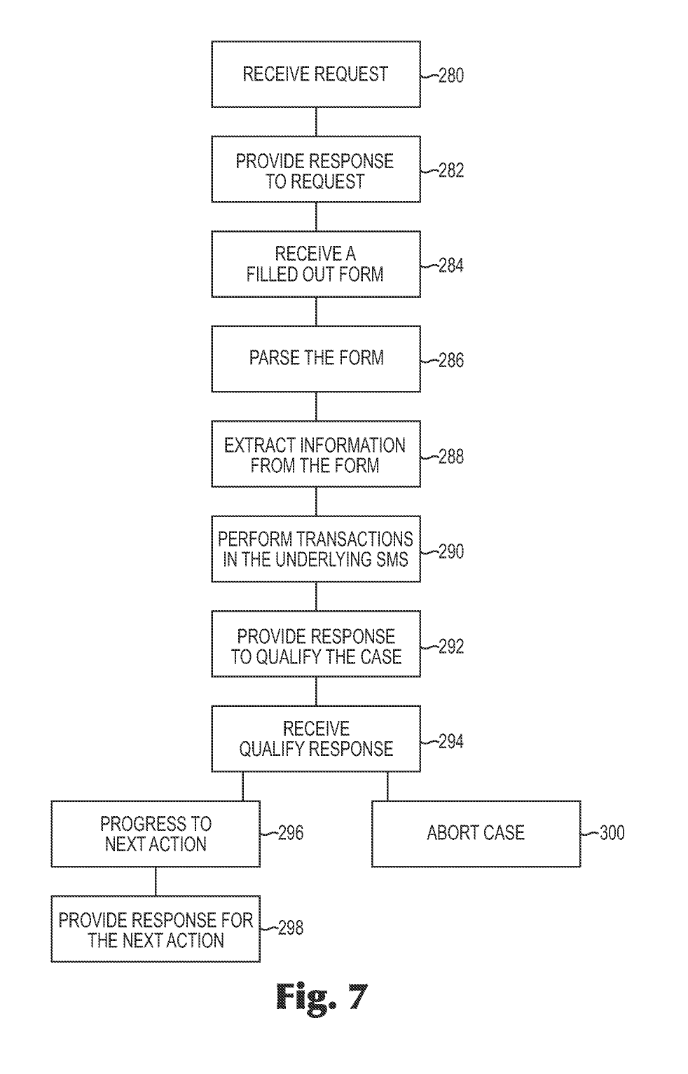

FIG. 7 is a flow chart diagram illustrating one example of sales system 100 and sales governance system 22 creating a sales case.

Personnel, such as sales personnel, send a request to sales governance system 22 in a first email to create a sales case. The request includes a unique character string, such as “#create_sales_opportunity”, which indicates the request to create a sales case. At 280, sales governance system 22 receives the request in the first email and interprets the request in the context of a sales process. At 282, sales governance system 22 responds to the request by providing a response in a second email based on an interpretation of the request in the context of the sales process. To create a case, sales governance system 22 provides a case identification tag, such as “#case_{—}348753”, and a form in the second email. The case identification tag is used in forthcoming emails between personnel and sales governance system 22 to identify the sales case.

A person, such as a sales professional, receives the second email including the form and fills out the form according to instructions in the second email. The person then sends the filled out form back to sales governance system 22 in a third email. At 284, sales governance system 22 receives the third email including the filled out form. At 286, fulfillment interpreter 114 activates parsing of the form and parses the form. At 288, fulfillment interpreter 114 extracts information from the form and, at 290, fulfillment interpreter 114 performs transactions, such as storing information extracted from the form, in the underlying sale management systems 24.

Sales governance system 22 provides a fourth email at 292, which directs personnel to qualify the case and respond back with a fifth email that either qualifies the case via a unique character string, such as “#qualify_pursuit” or aborts the case via a unique character string, such as “#abort_case”. Sales governance system 22 maintains the sales process at the current step until it receives the fifth email at 294. If sales governance system 22 receives the “#qualify_pursuit” instruction at 294, sales governance system 22 progresses to the next action in the sales process at 296, and sales governance system 22 provides one or more email responses for the next action to personnel in the sales process at 298. If sales governance system 22 receives the not qualified or “#abort_case” instruction at 294, sales governance system 22 aborts the case at 300.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A system comprising:
one or more processors; and
memory that stores computer-executable instructions that control the one or more processors to:
receive requests;
interpret the requests in the context of a process; and
provide responses based on interpretations of the requests in the context of the process.

2. The system of claim 1, wherein the computer-executable instructions control the one or more processors to:
receive a request to create a case; and
provide a case identification character string in response to the request to create a case.

3. The system of claim 1, wherein the computer-executable instructions control the one or more processors to:
receive material based on the responses;
process the material; and
perform transactions in underlying sales management systems based on information from the material.

4. The system of claim 3, wherein the computer-executable instructions control the one or more processors to:
provide instructions for performing a follow-on action after receiving the material.

5. The system of claim 1, wherein the computer-executable instructions control the one or more processors to:
update a state of the process based on information from the requests; and
provide follow-on responses based on updating the state of the process.

6. The system of claim 1, wherein the computer-executable instructions control the one or more processors to:
receive a request to provide a list of actions to be performed in the process; and
provide the list of actions to be performed in the process in one of the responses.

7. The system of claim 1, wherein the computer-executable instructions control the one or more processors to:
provide a template that includes collateral information for performing an action to be performed in the process.

8. The system of claim 1, wherein the computer-executable instructions control the one or more processors to:
receive a request to provide a status report on at least one of progress in the process and an action to be performed in the process; and
provide the status report.

9. The system of claim 1, wherein the computer-executable instructions control the one or more processors to:
receive a request to update instructions for an action to be performed in the process; and
update at least one of the instructions and a template including collateral information for performing the action to be performed in the process.

10. A computer readable storage medium storing computer-executable instructions for controlling one or more processors to perform a method comprising:
receiving a request that indicates an action to be performed;
providing a response to the request, wherein the response includes instructions for performing the action to be performed;
receiving material according to the instructions;
processing the material; and
performing transactions in underlying systems based on information from the material.

11. The computer readable storage medium of claim 10, wherein processing the material comprises:
parsing the material; and
extracting the information from the material.

12. The computer readable storage medium of claim 10, the method comprising:
providing confirmation that the transactions were successfully performed.

13. The computer readable storage medium of claim 10, the method comprising:
providing a case identification character string in the response to the request.

14. The computer readable storage medium of claim 10, the method comprising:
publishing a list of actions to be performed in a sales process.

15. The computer readable storage medium of claim 10, the method comprising:
providing other instructions for another action to be performed after receiving the material according to the instructions.

16. The computer readable storage medium of claim 10, the method comprising:
providing a template in the response, wherein the template includes at least one of forms, spreadsheets, calculators, slide decks, and reference contacts.

17. The computer readable storage medium of claim 10, the method comprising:
providing updated information on at least one of a process, status of the process, previous transactions, and previously provided information.

18. A computer implemented method comprising:
receiving a request to create a case in a first email;
providing a case identification tag and a form in a second email in response to the request;
receiving the form in a third email;
parsing the form;
extracting information from the form; and
performing transactions in underlying systems based on the information from the form.

19. The computer implemented method of claim 18 comprising:
receiving another request to perform an action from a list of actions in a sales process;
providing a template that includes instructions in response to the other request;
receiving material according to the instructions;
processing the material to extract information from the material; and
performing other transactions in the underlying systems based on the information from the material.

20. The computer implemented method of claim 18 comprising:
providing a fourth email to qualify the case;
progressing to a next action in a sales process if the case is qualified; and
providing a response for the next action in another email.
